(19) United States
(12) Patent Application Publication
(10) Pub. No.: US 2024/0260783 A1
(43) Pub. Date: Aug. 8, 2024

(54) Latte Art Cup

(71) Applicant: Jiaqi Zhao, San Jose, CA (US)

(72) Inventor: Jiaqi Zhao, San Jose, CA (US)

(21) Appl. No.: 18/104,842

(22) Filed: Feb. 2, 2023

(51) Int. Cl. A47J 31/44

(52) U.S. Cl. CPC A47J 31/4403; A47J 31/4496

(57) ABSTRACT

The proposed subject matter is a latte art cup designed to help guide a barista in the creation of latte art in the cup. The latte art cup has lines in the cup which give guidance and direction while pouring the latte and foam which comprises the latte art. The latte art cup makes the creative process easier by helping the artist visualize the process with precision.

### FIELD OF THE INVENTION

The present subject matter is a latte art cup that guides the barista in the creative process.

### BACKGROUND OF THE INVENTION

Prior to the present subject matter, baristas would usually talk about the process and try to guide new workers rather than having actual lines in the cup. To create a successful cup of latte art the barista needs to fill the cup halfway and then start to pour fast. The instructions given to new baristas were general and confusing for the average new barista to follow. Mistakes can be made and the art does not turn out to be as clear & defined as it should be.

The latte artist uses a series of steps to help create recognizable designs such as hearts and tulips. The typical process involves holding a cup of espresso at a 45-degree angle, pouring the frothed milk into a cup, mixing the coffee with the frothed milk as you pour for a smooth base color and then stop pouring once the cup is halfway full.

Once the cup is halfway full, connect the pitcher spout to the cup and start pouring at a faster but even speed. White foam should start to form a shape on the surface of the coffee. Once the cup is 90-95% full, lift the pitcher up from the cup while pouring. While pouring, move the pitcher to the direction where the spout points in a straight line to create a sharp point. Following these instructions should result in a heart shape on top of the coffee.

The present subject matter is meant to help facilitate the learning process of the above outlined steps by using two tangentially connected circles located inside the latte art cup as visual indicators on when to transition steps.

### SUMMARY OF THE INVENTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

As described herein, the term “pivotally connected” shall be used to describe a situation wherein two or more identified objects are joined together in a manner that allows one or both of the objects to pivot, and/or rotate about or in relation to the other object in either a horizontal or vertical manner.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include hardware components or modules that, for purposes of discussion, may be illustrated and described as if the majority of the components were implemented solely in hardware. It should be noted that a plurality of hardware devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

The present subject matter comprises of a cup with multiple guiding lines which help the barista to create latte art in the cup. The lines in the cups to give directions and guidance while pouring the art.

The cup consists of an ordinary latte cup, however, two tangentially connected circles are in the interior and are used as indicator lines for each stage of the creative process.

The smaller of the two tangentially connected circles indicates the angle and volume of liquid that should initially be placed in the container before beginning the creative process.

The larger of the two tangentially connected circles indicates the volume of liquid when the cup is full and provides a sense of timing with regard to when the art needs to be completed.

In some embodiments, the mirror image of the present subject matter or when the tangentially connected circles are oriented in a 90-degree angle away from a left-handed user is claimed.

In some embodiments, the circles may be of different colors to help indicate the sequential fill points.

While several illustrative embodiments of the invention have been shown and described, numerous variations and alternative embodiments will occur to those skilled in the art. Such variations and alternative embodiments are contemplated and can be made with departing from the scope of the invention as defined in the appended claims.

### BRIEF DESCRIPTION OF THE INVENTION

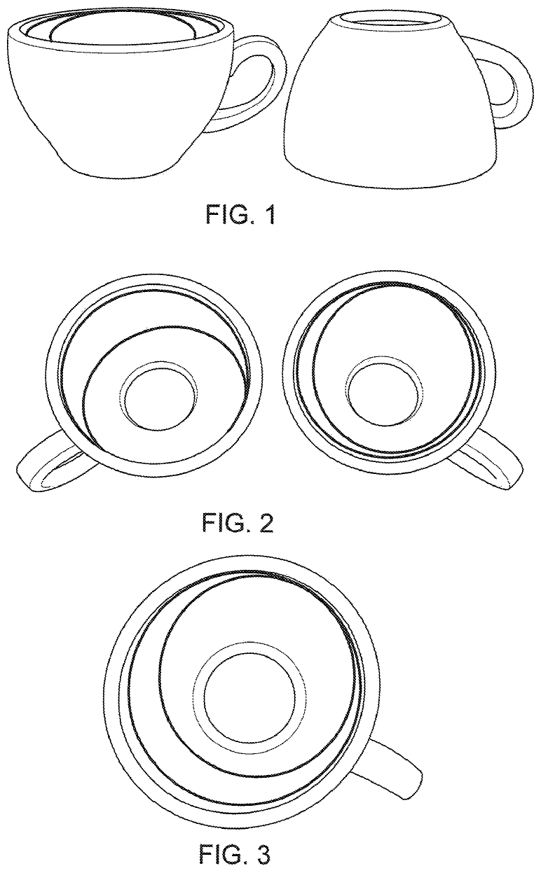

FIG. 1 shows a side view of the art latte cup.

FIG. 2 shows a perspective view of the art latte cup.

FIG. 3 shows a top view of the art latte cup.

### DETAILED DESCRIPTION OF THE INVENTION

FIG. 1 shows a side view of the art latte cup wherein the two tangentially connected circles can be seen in the right side up cup. A second cup can be seen sitting upside down.

FIG. 2 shows a perspective view of two art latte cups wherein two tangentially connected circles meet at a 90-degree orientation away from a right-handed user.

FIG. 3 shows a top view of a latte art cup wherein two tangentially connected circles are used to assist a barista in creating foam art.

We claim:

1. A latte art cup comprising of a cup with a handle and two tangentially connected circles.

2. The latte art cup comprising of the cup with a handle and two tangentially connected circles as in claim 1, wherein the tangentially connected circles are oriented in such a way as to facilitate latte art;

3. The latte art cup comprising of the cup with a handle and two tangentially connected circles as in claim 1, wherein the smaller of the two tangentially connected circles indicates how to angle the cup and how far to initially fill the latte art cup;

4. The latte art cup comprising of the cup with a handle and two tangentially connected circles as in claim 1, wherein the larger of the two tangentially connected circles indicates when the latte art cup is full and by when the artistic process must be completed.

5. The latte art cup comprising of the cup with a handle and two tangentially connected circles as in claim 1, wherein the two tangentially connected circles are of different colors to indicate sequential fill points;

6. A method of using a latte art cup comprising of a cup with a handle and two tangentially connected circles.

7. The method of using the latte art cup comprising of the cup with a handle and two tangentially connected circles as in claim 5, wherein the tangentially connected circles are oriented in such a way as to facilitate latte art;

8. The method of using the latte art cup comprising of the cup with a handle and two tangentially connected circles as in claim 5, wherein the smaller of the two tangentially connected circles indicates how to angle the cup and how far to initially fill the latte art cup;

9. The method of using the latte art cup comprising of the cup with a handle and two tangentially connected circles as in claim 5, wherein the larger of the two tangentially connected circles indicates when the latte art cup is full and by when the artistic process must be completed;

10. The method of using the latte art cup comprising of the cup with a handle and two tangentially connected circles as in claim 5, wherein the two tangentially connected circles are of different colors to indicate sequential fill points.
